(19) United States
(12) Patent Application Publication
(10) Pub. No.: US 2023/0243722 A1
(43) Pub. Date: Aug. 3, 2023

(54) BLADE ROLLER DEVICE, BLADE EXCHANGE APPARATUS HAVING THE SAME, AND MICROTOME HAVING SAME

(71) Applicant: Leica Biosystems Nussloch GmbH, Nussloch (DE)

(72) Inventors: Zheguang FAN, Pudong, Shanghai (CN); Haixia ZHANG, Pudong, Shanghai (CN)

(21) Appl. No.: 17/773,160

(22) PCT Filed: Oct. 30, 2019
(86) PCT No.: PCT/CN2019/114297

§ 371 Date: Apr. 29, 2022

(51) Int. Cl. G01N 1/06

(52) U.S. Cl. CPC G01N 1/06; G01N 2001/061

(57) ABSTRACT

A blade roller device (100) includes a first blade roll unit (110), a second blade roll unit (120) spaced apart from the first blade roll unit (110), and a first rotate lever (130). The first blade roll unit (110) includes a first slewing mechanism (111) and a first blade roll (112) wound upon the first slewing mechanism (111). The second blade roll unit (120) includes a second slewing mechanism (121) coupled to the first rotate lever (130) and a second blade roll (122) formed by pulling a segment of the first blade roll (112) to the second slewing mechanism (121) and winding the segment of the first blade roll (112) upon the second slewing mechanism (121). A rotation of the first rotate lever (130) in a first direction is capable of pulling the segment of first blade roll (112) to the second slewing mechanism (121).

### FIELD

The present disclosure relates to a technical field of microtomes, and more specifically, to a blade roller device, a blade exchange apparatus having the same, and a microtome having the same.

### BACKGROUND

In a microtome, a disposable blade is used for cutting specimen. After cutting several specimens, the disposable blade becomes dull and needs to be changed. A blade exchange workflow in the conventional microtome is like this: a user rotates a clamping level to release the used blade, pushes the used blade out from the blade holder, and inserts the blade to a scrap blade box, then pushes a new blade out from a new blade box, inserts it to the blade holder, and rotates the clamping level to clamp the blade holder. The conventional microtome is illustrated in FIG. 1 of the present application.

In the process of exchanging the blade, the user needs to push or hold the blade by hand, which puts the user into an injure risk on one hand, and on the other hand, hinders efficiency improvement of the blade exchange operation, hence causes an unsatisfactory performance of the microtome.

### SUMMARY

The present disclosure aims to solve at least one of the above-mentioned technical problems to at least some extent.

An object of the present disclosure is to provide a blade roller device.

According to some embodiments of the present disclosure, the blade roller device includes a first blade roll, a second blade roll, a second slewing mechanism, and a first driving mechanism connected to the second slewing mechanism. The second blade roll is wound upon the second slewing mechanism. The first driving mechanism is configured to drive a segment of the first blade roll to move towards the second slewing mechanism.

According to some embodiments of the present disclosure, the blade roller device further includes a first slewing mechanism, and the first blade roll is wound upon the first slewing mechanism.

According to some embodiments of the present disclosure, the blade roller device includes a first blade roll unit, a second blade roll unit spaced apart from the first blade roll unit, and a first driving mechanism. The first blade roll unit includes a first slewing mechanism and a first blade roll wound upon the first slewing mechanism. The second blade roll unit includes a second slewing mechanism coupled to the first driving mechanism and a second blade roll formed by pulling a segment of the first blade roll to the second slewing mechanism and winding the segment of the first blade roll upon the second slewing mechanism. The first driving mechanism is configured to drive the segment of first blade roll to move towards the second slewing mechanism.

According to some embodiments of the present disclosure, the first slewing mechanism includes a first portion and a second portion, the second portion rotatably surrounds the first portion, and the blade is wound upon an outer circumferential wall of the second portion; and the second slewing mechanism includes a third portion and a fourth portion, the fourth portion rotatably surrounds the third portion, and the blade is wound upon an outer circumferential wall of the fourth portion.

According to some embodiments of the present disclosure, the first driving mechanism is coupled to the fourth portion.

According to some embodiments of the present disclosure, the first portion is a shaft, and the second portion is a bearing; and the third portion is a shaft, and the fourth portion is a bearing.

According to some embodiments of the present disclosure, the first driving mechanism is a first rotate lever.

According to some embodiments of the present disclosure, the first rotate lever includes a first main body and a first handle, the first main body is connected to the second slewing mechanism.

According to some embodiments of the present disclosure, the segment of the first blade roll is pulled towards the second blade roll unit by rotating the first rotate lever.

According to some embodiments of the present disclosure, the first main body and the first handle are formed integrally or connected with each other.

According to some embodiments of the present disclosure, a second driving mechanism is provided and connected to the first slewing mechanism, and the second driving mechanism is configured to drive a segment of second blade roll to the first slewing mechanism.

According to some embodiments of the present disclosure, the second driving mechanism is a second rotate lever including a second main body and a second handle, and the second main body is connected to the first slewing mechanism.

According to some embodiments of the present disclosure, the first rotate lever and the second rotate lever shares same shape and dimension.

According to some embodiments of the present disclosure, a minimum driving force of each of the first slewing mechanism and/or the second slewing mechanism is a preset value.

According to some embodiments of the present disclosure, each of the first blade roll and the second blade roll is formed by a flexible blade.

With the blade roller device according to embodiments of the present disclosure, the blade can be moved from the first blade roll such as a new blade roll to the second blade roll such as a used blade roll by rotating the first rotate lever, in this way, the user does not need to touch the blade by hand, which prevents the injure risk on one hand, and saves time for blade exchange on the other hand.

Another object of the present disclosure is to provide a blade exchange apparatus, which includes the above-mentioned blade roller device and a blade holder assembly. The blade holder assembly includes a blade holder including a body and a pressure plate movably connected to each other, and a clamping lever connected to the blade holder. The blade is clamped between the body and the pressure plate or released therefrom by rotating the clamping lever.

According to some embodiments of the present disclosure, the first blade roll is formed by an unused blade and the second blade roll is formed by a used blade.

According to some embodiments of the present disclosure, when the segment of the first blade roll is released from the body and the pressure plate, the segment of the first blade roll is pulled towards the second blade roll unit.

With the blade exchange apparatus equipped with the blade roller device according to embodiments of the present disclosure, the blade can be exchange conveniently and rapidly, the user does not need to touch the blade by hand, which prevents the injure risk on one hand, and saves time for blade exchange on the other hand.

Yet another object of the present disclosure is to provide a microtome, which includes the above-mentioned blade roller device.

With the microtome equipped with the blade roller device according to embodiments of the present disclosure, the blade can be exchange conveniently and rapidly, the user does not need to touch the blade by hand, which prevents the injure risk on one hand, and saves time for blade exchange on the other hand.

### BRIEF DESCRIPTION OF THE DRAWINGS

These and additional aspects and advantages of embodiments of the present disclosure will become apparent and more readily appreciated from the following descriptions made with reference to the drawings, in which:

FIG. 1 illustrates a perspective view of a conventional microtome.

FIG. 2 illustrates a schematic view of a blade roller device according to an embodiment of the present disclosure.

FIG. 3 illustrates a schematic view of a blade roller device according to another embodiment of the present disclosure.

FIG. 4 illustrates a schematic section view of a blade roller device according to an embodiment of the present disclosure.

FIG. 5 illustrates a schematic section view of a blade roller device according to another embodiment of the present disclosure.

FIG. 6 illustrates a schematic view of a blade exchange apparatus according to an embodiment of the present disclosure.

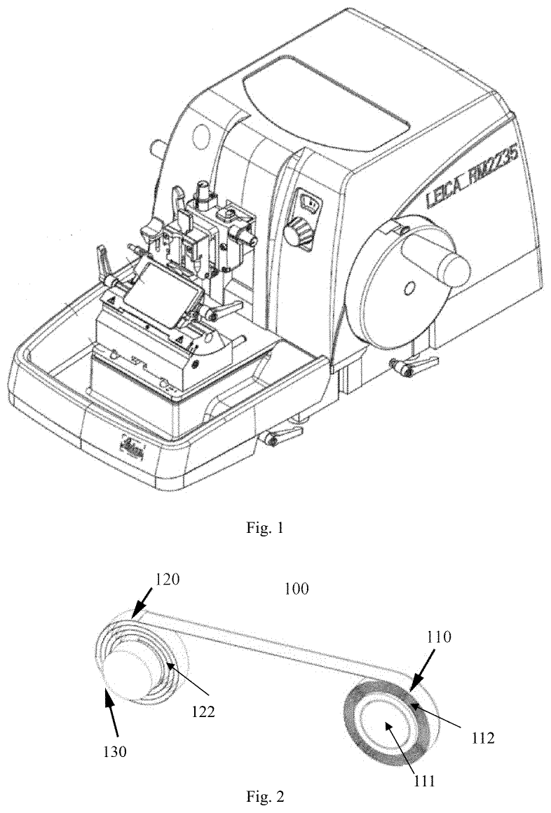

### REFERENCES NUMERALS

blade roller device 100

first blade roll unit 110, first slewing mechanism 111, first blade roll 112, first portion 1111, second portion 1112

second blade roll unit 120, second slewing mechanism 121, second blade roll 122, third portion 1211, fourth portion 1212

first rotate lever 130, first main body 131, first handle 132,

second rotate lever 140, second main body 141, second handle 142

blade holder assembly 200

blade holder 210, body 211, pressure plate 212

clamping lever 220

blade exchange apparatus 10

### DETAILED DESCRIPTION

Embodiments of the present disclosure will be described in detail and examples of the embodiments will be illustrated in the accompanying drawing. The same or similar elements and the elements having same or similar functions are denoted by like reference numerals throughout the descriptions. The embodiments described herein with reference to the drawings are explanatory, which aim to illustrate the present disclosure, but shall not be construed to limit the present disclosure.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” should be construed to refer to the orientation or position as then described or as illustrated in the drawings under discussion. These relative terms are for convenience of description, and do not indicate or imply that the device or element referred to must have a particular orientation or be constructed and operated in a particular orientation, and hence cannot be constructed to limit the present disclosure. In addition, the feature defined with “first” and “second” may indicate or imply including one or more of this feature. In the description of the present disclosure, the term “a plurality of” means two or more than two, unless specified otherwise.

In the description of the present disclosure, it should be understood that, unless specified or limited otherwise, the terms “mounted,” “connected,” and “coupled” and variations thereof are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

An object of the present disclosure is to provide a blade roller device, which includes a first blade roll, a second blade roll, a second slewing mechanism, and a first driving mechanism. The second blade roll is wound upon the second slewing mechanism. The first driving mechanism is configured to drive a segment of the first blade roll to move towards the second slewing mechanism.

Another object of the present disclosure is to provide a blade roller device, which includes a first blade roll unit, a second blade roll unit spaced apart from the first blade roll unit, and a first driving mechanism. The first blade roll unit includes a first slewing mechanism and a first blade roll wound upon the first slewing mechanism. The second blade roll unit includes a second slewing mechanism coupled to the first driving mechanism and a second blade roll formed by pulling a segment of the first blade roll to the second slewing mechanism and winding the segment of the first blade roll upon the second slewing mechanism. The first driving mechanism is configured to drive the segment of first blade roll to move towards the second slewing mechanism.

Another object of the present disclosure is to provide a blade exchange apparatus, which includes the above-mentioned blade roller device and a blade holder assembly. The blade holder assembly includes a blade holder including a body and a pressure plate movably connected to each other, and a clamping lever connected to the blade holder. The blade is clamped between the body and the pressure plate or released therefrom by rotating the clamping lever.

Yet another object of the present disclosure is to provide a microtome, which includes the above-mentioned blade roller device.

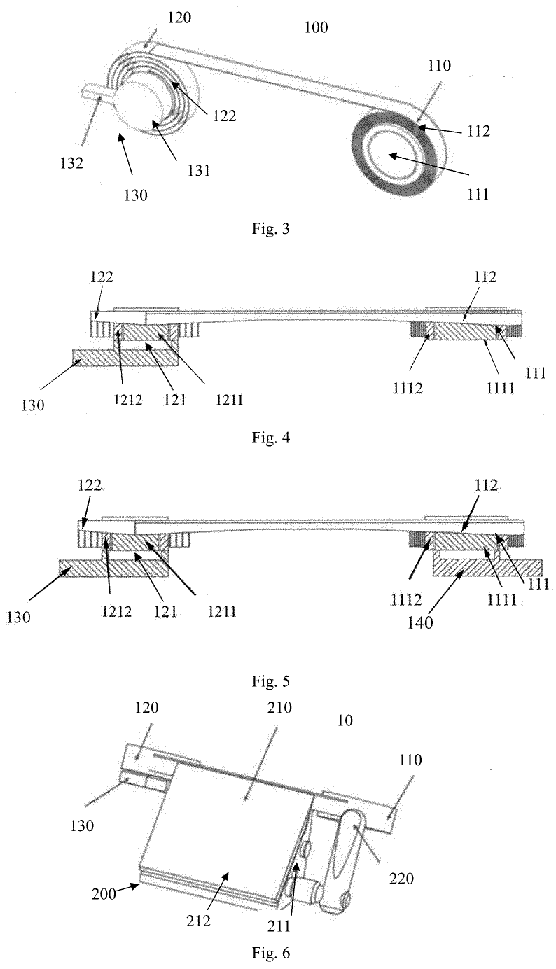

A blade roller device 100 according to an embodiment of the present disclosure is described with reference to FIG. 2 to FIG. 5.

In some embodiments of the present disclosure, the blade roller device 100 includes a first blade roll 112, a second blade roll 122, a second slewing mechanism 121 and a first driving mechanism connected to the second slewing mechanism 121. The second blade roll 122 is wound upon the second slewing mechanism 121. The first driving mechanism is configured to drive a segment of the first blade roll 112 to move towards the second slewing mechanism 121.

In some embodiments of the present disclosure, the blade roller device 100 further includes a first slewing mechanism 111, and the first blade roll 112 is wound upon the first slewing mechanism 111.

In some embodiments of the present disclosure, the blade roller device 100 includes a first blade roll unit 110, a second blade roll unit 120, and a first driving assembly. The first blade roll unit 110 and the second blade roll unit 120 are spaced apart. The first blade roll unit 110 includes a first slewing mechanism 111 and a first blade roll 112. The first blade roll 112 is formed by winding a blade upon the first slewing mechanism 111. The second blade roll unit 120 includes a second slewing mechanism 121 and a second blade roll 122. The second blade roll 122 is formed by pulling a segment of the blade from the first slewing mechanism 111 to the second slewing mechanism 121 and winding the blade upon the second slewing mechanism 121. The first driving mechanism is configured to drive a segment of the first blade roll 112 to move towards the second slewing mechanism 121.

The blade is flexible so as to be wound upon the first slewing mechanism 111 and the second slewing mechanism 121. The first blade roll unit 110 and the second blade roll unit 120 are connected with each other by the blade, in other words, the blade is stretched tightly between the first blade roll 112 and the second blade roll 122.

In some embodiments of the present disclosure, the first driving mechanism and the second slewing mechanism 111 are formed integrally or connected with each other.

In some embodiments of the present disclosure, the first slewing mechanism 111 includes a first portion 1111 and a second portion 1112, the second portion 1112 rotatably surrounds the first portion 1111, and the blade is wound upon an outer circumferential wall of the second portion 1112; and the second slewing mechanism 121 includes a third portion 1211 and a fourth portion 1212, the fourth portion 1212 rotatably surrounds the third portion 1211, and the blade is wound upon an outer circumferential wall of the fourth portion 1212.

In some embodiments of the present disclosure, each of the first portion 1111 and the third portion 1211 is a shaft, and each of the second portion 1112 and the fourth portion 1212 is a bearing.

In some embodiments of the present disclosure, the first driving mechanism is a first rotate lever 130.

In some embodiments of the present disclosure, when the first rotate lever 130 is rotated counterclockwise, the blade is pulled from the first blade roll unit 110 to the second blade roll unit 120.

In some embodiments of the present disclosure, the first rotate lever 130 includes a first main body 131 and a first handle 132. The first main body 131 is connected to the second slewing mechanism 121. The user can rotate the first rotate lever 130 by turning the first handle 132.

In some embodiments of the present disclosure, the first handle 132 and the first main body 131 are formed integrally. In this way, the manufacturing of the first rotate lever 130 is facilitated.

In some embodiments of the present disclosure, the first handle 132 and the first main body 131 are connected with each other. For example, the first handle 132 is connected to a peripheral wall of the first main body 131 by welding. In this way, the first handle 132 and the first main body 131 can be connected securely. Or, the first handle 132 and the first main body 131 are fitted by screw connection. In this way, the first handle 132 and the first main body 131 can be detachably connected, and the assembly of the first rotate lever 130 is facilitated. Those skilled in the art can adopt any suitable technical solutions to connect the first handle 132 to the first main body 131, which will not be elaborated.

In some embodiments of the present disclosure, the first blade roll 112 is formed by winding the new blade upon the first slewing mechanism 111, and the second blade roll 122 is formed by winding the used blade upon the second slewing mechanism 121.

With the blade roller device 100 according to embodiments of the present disclosure, the blade can be moved from the first blade roll 112 such as the new blade roll to the second blade roll 122 such as the used blade roll by rotating the first rotate lever 130, in this way, the user does not need to touch the blade by hand, which prevents the injure risk on one hand, and saves time for blade exchange on the other hand.

In some embodiments of the present disclosure, a second driving mechanism is further provided, and the second driving mechanism and the first slewing mechanism 111 are formed integrally or connected with each other. The second driving mechanism is configured to drive a segment of second blade roll 122 to the first slewing mechanism 111.

In some embodiments of the present disclosure, the second driving mechanism is a second rotate lever 140 including a second main body 141 and a second handle 142, and the second main body 141 is connected to the first slewing mechanism 111.

In some embodiments of the present disclosure, when the second rotate lever 140 is rotated clockwise, the blade is pulled from the second blade roll unit 120 to the first blade roll unit 110.

In some embodiments of the present disclosure, the second rotate lever 140 includes a second main body 141 and a second handle 142, and the second main body 141 is connected to the first slewing mechanism 111. The user can rotate the second rotate lever 140 by turning the second handle 142.

In some embodiments of the present disclosure, the second handle 142 and the second main body 141 are formed integrally. In this way, the manufacturing of the second rotate lever 140 is facilitated.

In some embodiments of the present disclosure, the second handle 142 and the second main body 141 are connected with each other. For example, the second handle 142 and the second main body 141 are fitted by screw connection. In this way, the second handle 142 and the second main body 141 can be detachably connected, and the assembly of the second rotate lever 140 is facilitated. Or, the second handle 142 is connected to the second main body 141 by welding. In this way, the second handle 142 and the second main body 141 can be connected securely. Those skilled in the art can adopt any suitable technical solutions to connect the second handle 142 to the second main body 141, which will not be elaborated.

In some embodiments of the present disclosure, the first rotate lever 130 and the second rotate lever 140 shares the same shape and size. In this way, the manufacturing of the first rotate lever 130 and the second rotate lever 140 is facilitated.

In some embodiments of the present disclosure, the first slewing mechanism 111 and the second slewing mechanism 121 are in the same dimension. In this way, the assembly of the blade roller device 100 can be facilitated.

In some embodiments of the present disclosure, a minimum driving force of the first slewing mechanism 111 and/or the second slewing mechanism 121 is a preset value. For example, the minimum driving force of each of the first slewing mechanism 111 and the second slewing mechanism 121 can be, but not limited to, 2N, 3N, 4N or 5N, which can be decided according to actual requirements by adjusting such as a friction coefficient of contact surfaces of the first slewing mechanism 111 and the second slewing mechanism 121.

In some embodiments of the present disclosure, the blade is made of metal such as tool steel, high speed steel and carbide, as long as the blade is flexible and can be would upon the first slewing mechanism and the second slewing mechanism.

In some embodiments of the present disclosure, when the blade roller device 100 is put into an operating state, the first blade roll unit 110 and the second blade roll unit 120 are spaced apart, and the blade is stretched tightly between the first blade roll 112 and the second blade roll 122. When the blade roller device 100 is in a non-operating state, the blade between the first blade roll 112 and the second blade roll 122 is loosed and wound upon the first slewing mechanism 111 or the second slewing mechanism 121, so that the first blade roll unit and the second blade roll unit 120 can be moved adjacent to each other.

FIG. 6 is referred to describe a blade exchange apparatus 10 according to embodiments of the present disclosure.

The blade exchange apparatus 10 according to embodiments of the present disclosure includes a blade roller device 100 as mentioned above and a blade holder assembly 200.

The blade holder assembly 200 includes a blade holder 210 and a clamping lever 220. The clamping lever 220 is connected to the blade holder 210.

The blade holder 210 includes a body 211 and a pressure plate 212. The body 211 and the pressure plate 212 are movably connected to each other. The pressure plate 212 can be driven to move relative to the body 211 by means of the clamping lever 220. The blade stretched between the first blade roll unit 110 and the second blade roll unit 120 can be clamped between the body 211 and the pressure plate 212 or released therefrom by rotating the clamping lever 220.

When the clamping lever 220 is rotated in a third direction, the pressure plate 212 is driven to move towards the body 211 so as to clamp the blade between the pressure plate 212 and the body 211 tightly, and when the clamping lever 220 is rotated in a fourth direction, the pressure plate 212 is driven to move away from the body 211 so as to release the blade between the pressure plate 212 and the body 211.

In some embodiment, when the clamping lever 220 is rotated in a direction towards the blade roller device 100 and away from the user, the pressure plate 212 is driven to move towards the body 211 so as to clamp the blade between the pressure plate 212 and the body 211 tightly, and when the clamping lever 220 is rotated in a direction away from the blade roller device 100 and towards the user, the pressure plate 212 is driven to move away from the body 211 so as to release the blade between the pressure plate 212 and the body 211.

The other configuration of the blade holder assembly 200 is same with those in the conventional microtome, which will not be elaborated here.

The workflow of the blade exchange apparatus 10 according to some embodiments of the present disclosure is described in detail below.

During operation, the blade is clamped between the body 211 and the pressure plate 212. When the blade is dull, the use rotates the clamping lever 220 in the direction away from the blade roller device 100 and towards the user, the pressure plate 212 is driven to move away from the body 211, and the blade clamped between the pressure plate 212 and the body 211 is released. Then the user can rotate the first rotate lever 130 counterclockwise to pull the blade into the used blade roll unit, and new blade is pulled out of the new blade roll unit. When the blade of a desired length is pulled out, the user rotates the clamping lever 220 in the direction towards the blade roller device 100 and away from the user, so that the pressure plate 212 is driven to move towards the body 211 to clamp the new blade between the pressure plate 212 and the body 211 tightly.

The workflow of the blade exchange apparatus 10 according to some other embodiments of the present disclosure is described in detail below.

During operation, the blade is clamped between the body 211 and the pressure plate 212. When the blade is dull, the use rotates the clamping lever 220 in the direction away from the blade roller device 100 and towards the user, the pressure plate 212 is driven to move away from the body 211, and the blade clamped between the pressure plate 212 and the body 211 is released. Then the user can rotate the first rotate lever 130 counterclockwise to pull the blade into the used blade roll unit, and new blade is pulled out of the new blade roll unit. When the blade of the desired length is pulled out, the user rotates the clamping lever 220 in the direction towards the blade roller device 100 and away from the user, so that the pressure plate 212 is driven to move towards the body 211 to clamp the new blade between the pressure plate 212 and the body 211 tightly. If the new blade is pulled out too much, the user can rotate the second rotate lever 140 clockwise, so as to pull the excess part of the pulled blade back into the new blade roll unit.

With the blade exchange apparatus 10 equipped with the blade roller device 100 according to embodiments of the present disclosure, the blade can be exchanged conveniently and rapidly, the user does not need to touch the blade by hand, which prevents the injure risk on one hand, and saves time for blade exchange on the other hand.

The microtome according to embodiments of the present disclosure includes the blade exchange apparatus 10 as mentioned above.

The other configuration of the microtome is same with those in the conventional microtome, which will not be elaborated here.

With the microtome equipped with the blade roller device 100 according to embodiments of the present disclosure, the blade can be exchanged conveniently and rapidly, the user does not need to touch the blade by hand, which prevents the injure risk on one hand, and saves time for blade exchange on the other hand.

Reference throughout this specification to “an embodiment,” “some embodiments,” “an exemplary embodiment,” “an example,” “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

Although embodiments have been illustrated and described, it would be appreciated by those skilled in the art that changes, modifications, alternatives and variants can be made in the embodiments without departing from principles and purposes of the present disclosure. The protection scope of the present disclosure is defined by the claims or the like.

1. A blade roller device (100), comprising:
a first blade roll (112);
a second blade roll (122);
a second slewing mechanism (121), the second blade roll (122) being wound upon the second slewing mechanism (121); and
a first driving mechanism connected to the second slewing mechanism (121);
wherein the first driving mechanism is configured to drive a segment of the first blade roll (112) to move towards the second slewing mechanism (121).

2. The blade roller device (100) according to claim 1, further comprising a first slewing mechanism (111), wherein the first blade roll (112) is wound upon the first slewing mechanism (111).

3. A blade roller device (100), comprising:
a first blade roll unit (110);
a second blade roll unit (120) spaced apart from the first blade roll unit (110); and
a first driving mechanism;
wherein the first blade roll unit (110) comprises:
a first slewing mechanism (111); and
a first blade roll (112) wound upon the first slewing mechanism (111);
wherein the second blade roll unit (120) comprises:
a second slewing mechanism (121) coupled to the first driving mechanism; and
a second blade roll (122) formed by pulling a segment of the first blade roll (112) to the second slewing mechanism (121) and winding the segment of the first blade roll (112) upon the second slewing mechanism (121); and
the first driving mechanism is configured to drive the segment of the first blade roll (112) to move towards the second slewing mechanism (121).

4. The blade roller device (100) according to claim 2, wherein the first slewing mechanism (111) comprises a first portion (1111) and a second portion (1112), the second portion (1112) rotatably surrounds the first portion (1111), and the first blade roll (112) is wound upon an outer circumferential wall of the second portion (1112); and
the second slewing mechanism (121) comprises a third portion (1211) and a fourth portion (1212), the fourth portion (1212) rotatably surrounds the third portion (1211), and the second blade roll (122) is wound upon an outer circumferential wall of the fourth portion (1212).

5. The blade roller device (100) according to claim 4, wherein the first driving mechanism is coupled to the fourth portion (1212).

6. The blade roller device (100) according to claim 4, wherein the first portion (1111) is a shaft, and the second portion (1112) is a bearing; and the third portion (1211) is a shaft, and the fourth portion (1212) is a bearing.

7. The blade roller device (100) according to claim 2, wherein the first driving mechanism is a first rotate lever (130).

8. The blade roller device (100) according to claim 7, wherein the first rotate lever (130) comprises a first main body (131) and a first handle (132), and the first main body (131) is connected to the second slewing mechanism (121).

9. The blade roller device (100) according to claim 8, wherein the first main body (131) and the first handle (132) are formed integrally or connected with each other.

10. The blade roller device (100) according to claim 7, wherein the segment of the first blade roll (112) is pulled towards the second blade roll (120) by rotating the first rotate lever (130).

11. The blade roller device (100) according to claim 7, wherein a second driving mechanism is provided and connected to the first slewing mechanism (111), and the second driving mechanism is configured to drive a segment of the second blade roll (122) to the first slewing mechanism (111).

12. The blade roller device (100) according to claim 11, wherein the second driving mechanism is a second rotate lever (140) comprising a second main body (141) and a second handle (142), and the second main body (141) is connected to the first slewing mechanism (111).

13. The blade roller device (100) according to claim 12, wherein the first rotate lever (130) and the second rotate lever (140) share same shape and dimension.

14. The blade roller device (100) according to claim 2, wherein a minimum driving force of the first slewing mechanism (111) and/or the second slewing mechanism (121) is a preset value.

15. The blade roller device (100) according to claim 1, wherein each of the first blade roll (112) and the second blade roll (122) is formed by a flexible blade.

16. A blade exchange apparatus (10) for a microtome, comprising:
a blade holder assembly (200); and
a blade roller device (100);
wherein the blade holder assembly (200) comprises:
a blade holder (210) comprising a body (211) and a pressure plate (212) movably connected to the body (211); and
a clamping lever (220) connected to the blade holder (210);
wherein the blade roller device (100) comprises:
a first blade roll (112);
a second blade roll (122);
a second slewing mechanism (121), the second blade roll (122) being wound upon the second slewing mechanism (121); and
a first driving mechanism connected to the second slewing mechanism (121);
wherein the first driving mechanism is configured to drive a segment of the first blade roll (112) to move towards the second slewing mechanism (121);
wherein the segment of the first blade roll (112) is clamped between the body (211) and the pressure plate (212) or released therefrom by rotating the clamping lever (220).

17. The blade exchange apparatus (10) according to claim 16, wherein the first blade roll (112) is formed by an unused blade and the second blade roll (122) is formed by a used blade.

18. The blade exchange apparatus (10) according to claim 16, wherein when the segment of the first blade roll (112) is released from the body (211) and the pressure plate (212), the segment of the first blade roll (112) is pulled towards the second blade roll (120).
